(19) United States
(12) Patent Application Publication
(10) Pub. No.: US 2007/0017862 A1
(43) Pub. Date: Jan. 25, 2007

(54) Water recycling, high-pressure spray tire wash system

(76) Inventor: Donald S. Shaver, Las Vegas, NV (US)

Correspondence Address: LITMAN LAW OFFICES, LTD, PO BOX 15035, CRYSTAL CITY STATION, ARLINGTON, VA, 22215, US

(21) Appl. No.: 11/489,564

(22) Filed: Jul. 20, 2006

Related U.S. Application Data
(60) Provisional application No. 60/701,501, filed on Jul. 22, 2005.

(51) Int. Cl. B01D 12/00

(52) U.S. Cl. 210/513

(57) ABSTRACT

A high-pressure, water recycling, spray tire wash system with an elevated wash rack having water collection trays therebeneath. A number of high-pressure spray heads are spaced along each side of the wash rack for collecting used wash water. There are a plurality of high-pressure sprauy heads arranged along the side of the wash rack so as to direct water to the tires of a vehicle on the rack. Water collected on the trays is conveyed to a primary settling tank, and then a secondary tank, for clarification and polishing of the water, and then through filters to a holding tank where the polished and filtered water is stored awaiting use. High-pressure pumps direct water through hoses to spray head manifolds and then to the high-pressure spray heads, where water is ejected at a pressure ranging from about 900 psi to 1500 psi at the vehicle tires to clean them.

### CROSS-REFERENCE TO RELATED APPLICATION

This application claims the benefit of U.S. Provisional Patent Application Ser. No. 60/701,501, filed Jul. 22, 2005.

### BACKGROUND OF THE INVENTION

1. Field of the Invention

The present invention relates to water recycling wash racks. More particularly, the present invention relates to a high-pressure spray wash rack for tires.

2. Description of the Related Art

Construction and other vehicles having tires are prone to collection of mud and other substances on the tires during use. Driving onto a paved road transfers the mud to the road, leaving slick areas and unsightly debris. The operators of construction and similar work sites are often required to pay for cleaning the road at considerable expense. It is thus desirable to provide a washing facility for washing the tires before the vehicle enters a paved highway.

Washing facilities for tires are widely used at sites such as construction sites. Most such facilities use relatively low-pressure water spray(s), thus requiring a substantial amount of water, and leaving puddles in wash areas, even where water recycling is practiced. In dry areas, known systems lose substantial amounts of water due to evaporation. Also, some systems are difficult to move to another site. It would be desirable to provide a high-pressure water spray tire wash system having a water clarification and filtering recycling system that minimizes time spent washing, and the resultant exposure of water to the atmosphere where evaporation occurs, thus minimizing water loss. It would also be desirable if the tire washing system is easily dismantled, and moved to another location with minimum permanent disturbance of the land area.

Thus a water recycling tire wash system solving the aforementioned problems is desired.

### SUMMARY OF THE INVENTION

The high-pressure water recycling system of the present invention includes an elevated wash rack having water collection trays under the wash rack for collecting the used water. The wash rack has a number of high-pressure spray heads spaced along each side, supported so as to direct high-pressure water spray toward tires of a vehicle located on the wash rack. Water collected in the trays is conducted through drain lines to a primary settling tank for partially clarifying the used water. Water from the primary settling tank is conducted to a secondary settling tank for further clarification, and then this water is pumped by a sump pump to a series of screen and fiber filters. This filtered water is then conducted to a polished water tank for holding until use. When the tire wash is to be used, high-pressure pumps pump water from the holding tank to corresponding high-pressure hoses, thence to corresponding high-pressure spray head manifolds, and to a number of high-pressure spray heads, for delivery of water for washing tires in a minimum time. In this manner, exposure of water to the atmosphere is minimized, reducing evaporation and water loss.

These and other features of the present invention will become readily apparent upon further review of the following specification and drawings.

### BRIEF DESCRIPTION OF THE DRAWINGS

FIG. 1 is a plan view, partially cut away, and showing a water recycling, high-pressure spray tire wash system according to the present invention.

FIG. 2 is a perspective view of the tire wash system as shown in FIG. 1, and further showing the system in use.

FIG. 3 is a front elevation view of the tire wash system as shown in FIGS. 1 and 2, and further showing the system in use.

FIG. 4 is an elevation, exploded view of the tire wash system as shown in FIGS. 1 and 2.

FIG. 5 is an enlarged-scale, perspective view of one of the spray units shown in FIG. 1.

Similar reference characters denote corresponding features consistently throughout the drawing figures.

### DETAILED DESCRIPTION OF THE PREFERRED EMBODIMENTS

The present invention is a high-pressure tire wash, with water recycling, and useful with all types of vehicles, including construction equipment.

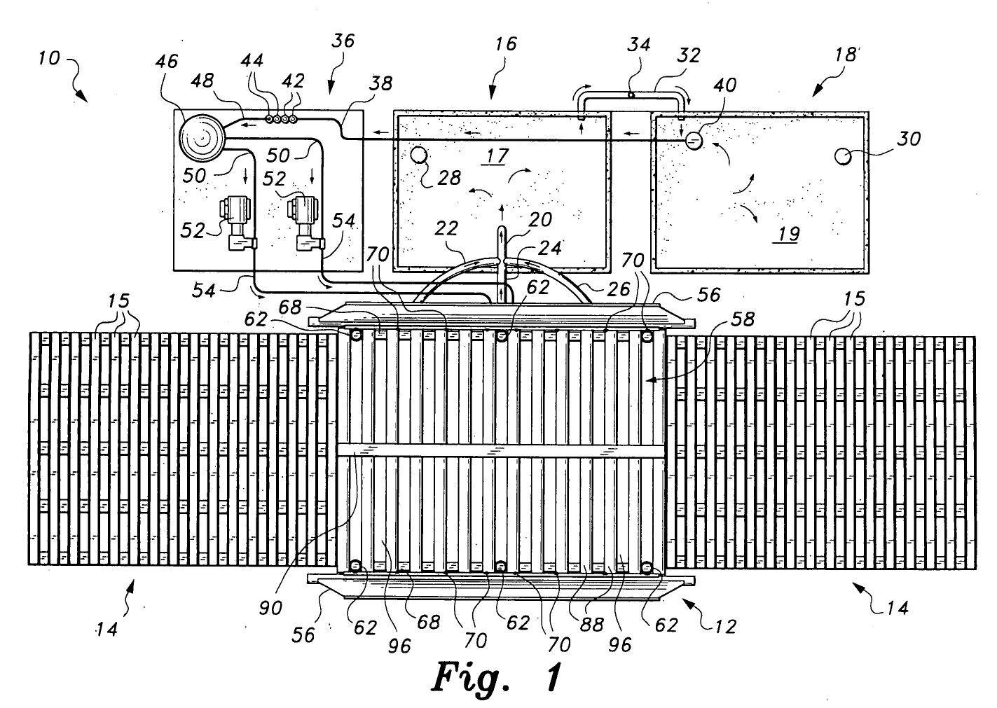

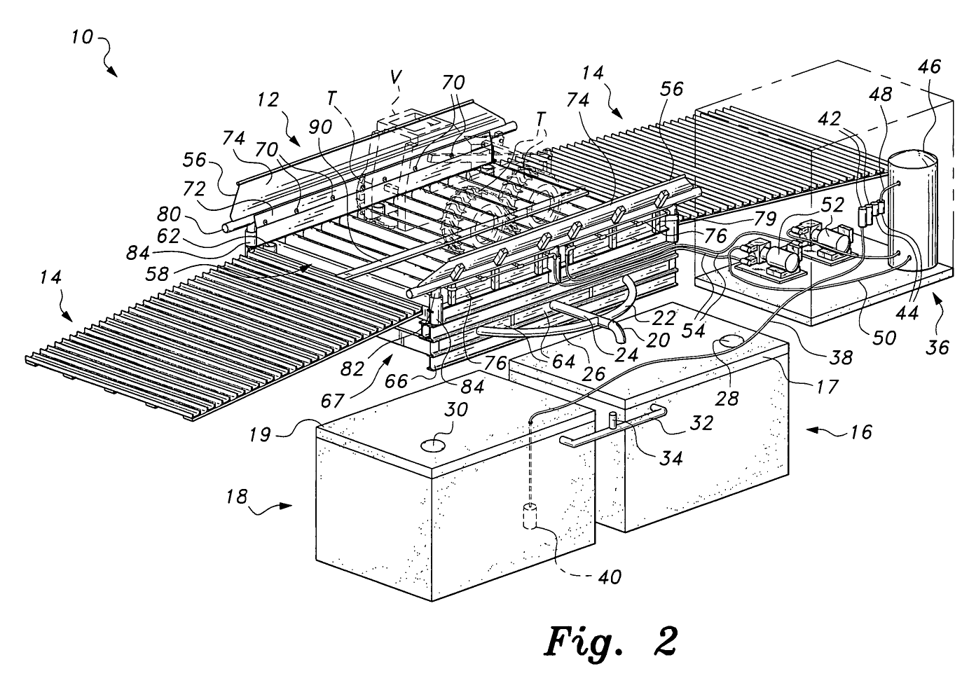

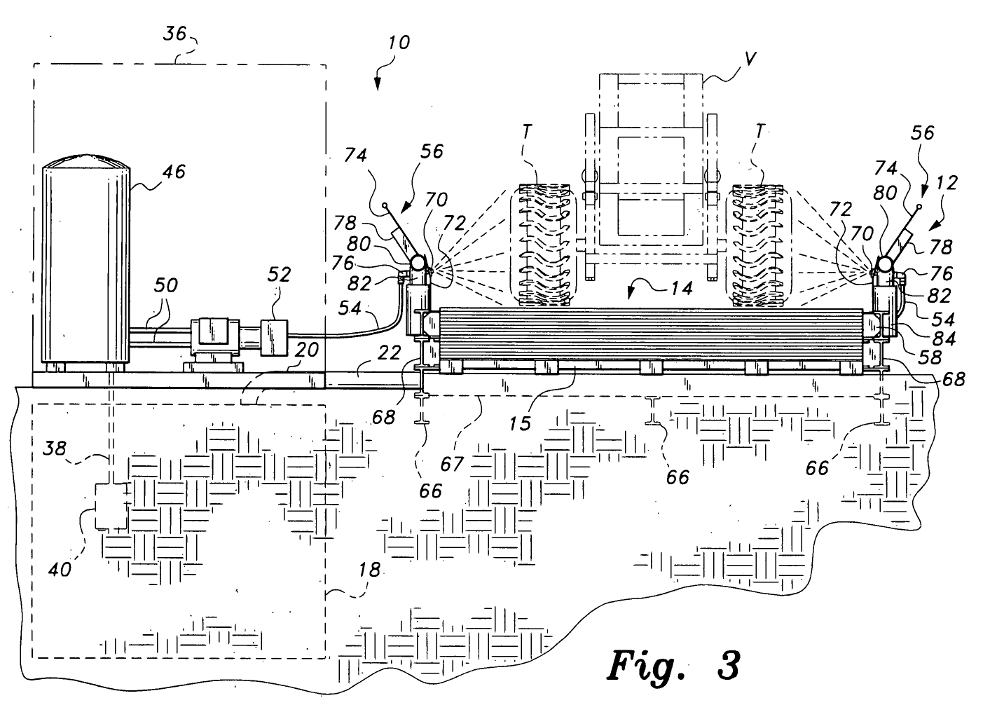

Referring to the drawing figures, high-pressure recycle tire wash system 10 includes an elevated wash rack 12, upon which a vehicle V (see FIGS. 2 and 3) having tires T to be washed is driven onto and off of ramps 14. Ramps 14 are made up of parallel arranged and mounted beams 15. With reference to and in the sense of FIG. 1, vehicles will enter a ramp 14 that is supported on the ground, from the left, and exit a ramp 14 on the right, which is supported on its exit end on clean pavement, preferably.

The installation includes a primary settling tank 16 having a lid 17, and a secondary settling tank 18 having a lid 19. Preferably, the tanks are buried up to their respective lids, so that used water from the system flows into the tanks by gravity. Primary settling tank feed line 20 delivers used wash water from first branch drain line 22, second branch drain line 24, and third branch drain 26 to primary settling tank 16 through its lid 17, by gravity. Alternatively, there could be four or more branch drain lines feeding into two, and then via a Y-fitting into the one feed line 20 and the tank 16 (not shown). While two tanks in series are shown, a third could be provided, if desired (not shown). That is about the limit, given normal water flow of around 120 gpm for tire washing in the system, at pressures ranging from about 900 to 1500 psi. Given these parameters for water requirements, any additional tanks would possibly make the system inefficient by not providing sufficient water when demanded; cost considerations are important here as well.

A settling tank transfer line 32 having a standpipe 34 therealong allows overflow of partially clarified water from primary settling tank 16 to secondary settling tank 18 by gravity, for further settling and clarification. Also, primary settling tank lid 17 and secondary tank lid 19 have respective removable pumpout caps 28 and 30 located for access by a pumpout truck for periodic removal of settled material. Conveniently, settling tanks 16 and 18 could be identical concrete septic tanks or the like, and the pumpout truck (not shown) a septic tank service truck. Incidentally, the excavated material removed for placement of the settling tanks is useful for forming the base for the ramps 14.

Referring now particularly to FIGS. 1 and 2, water from secondary settling tank 18 is pumped to a filtration and pumphouse 36 through filter feed line 38 from sump pump 40 submerged in secondary settling tank 18. The clarified water is then fed through two screen filters 42 and two fiber filters 44 of conventional design. The filtered water is then conveyed to polished water holding tank 46 via polished water tank feed line 48. Upon demand for water for wash rack 12, high-pressure pumps 52 pump water from tank 46 through pump supply lines 50 into high-pressure supply lines 54 to supply the polished water to spray units 56.

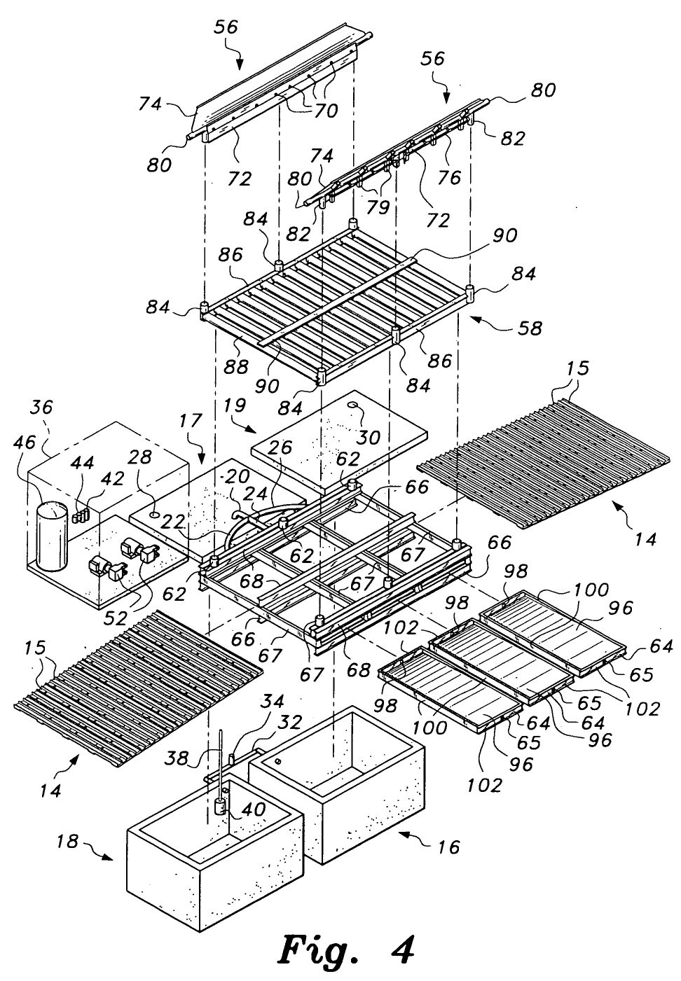

As best seen in FIGS. 2 and 3, spray units 56 are mounted on each side of a tubular, vehicle support unit 58. The unit 58 is supported by intermediate support rack 60, having vehicle support unit alignment cylinders 62 extending between the spaced tubes of vehicle support unit 58. A collection pan support frame 66 (best seen in FIG. 4) supports collection pan support cross beams 67 supporting pan support frame upper beams 68, providing for insertion and removal of collection trays 64 which collect wash water draining through the elevated vehicle support unit 58. Support 58 remains in place due to gravity.

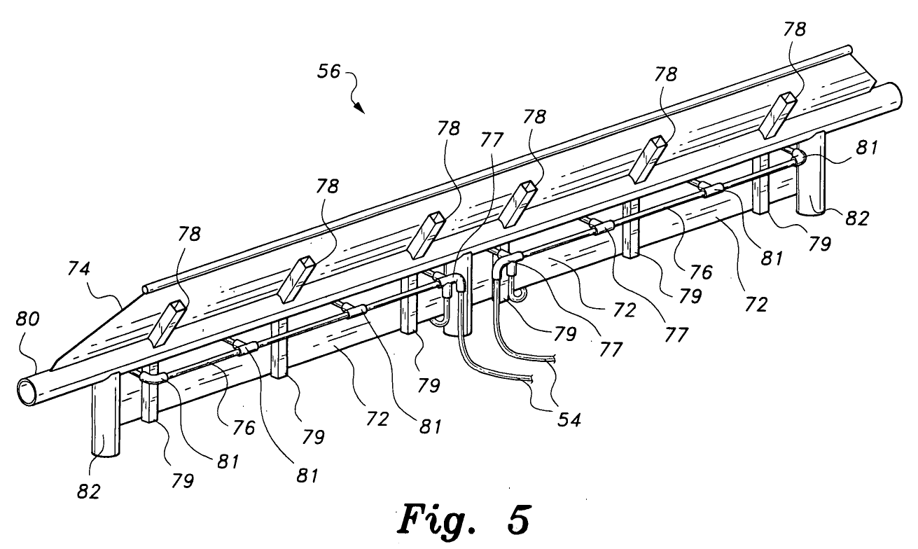

The spray units 70 include support walls 72 on each side of vehicle support unit 58, which support inwardly facing spray heads 70 spaced therealong. Spray catch walls 74 are attached along the upper edge of support walls 72 at attachment tubing 80, at an angle so as to splay outwardly, and catch the maximum amount of spray water splashing off the vehicle V and from the spray units 70. As best seen in FIG. 5, high-pressure water feed lines 54 are connected to forward and rear spray header feed splitters 77 feeding spray headers 76, and individual spray head feed tubes 81, on one side of wash rack 12. High-pressure water feed lines 54 continue from splitters 77 beneath vehicle support unit 58 to similar headers feeding spray heads 70 supported by the opposite side spray unit 56.

Tubular catch wall supports 78 extend upwardly from attachment tubing 80, and spray head support stiffeners 79 extend downwardly from attachment tubing 80 to firm up spray head support walls 72. Spray units 56 have spray unit guide cylinders 82 extending downwardly from their respective central portions and ends that are received by corresponding spray unit guide cylinder receivers 84 attached to side beams 86 of the tubular support rack 60 for accurate location and securing of spray units 56. The spray units 56 stay in place by force of gravity.

Vehicle support rack 60 is made up of a plurality of horizontally disposed, spaced cylinders 88 extending between side beams 80, and are centrally supported along the length of the vehicle support rack 60 by a center stiffener rod 90.

Referring now to FIG. 4, collection trays 64 are rectangular. Generally shallow trays having bottom walls 96 sloping downwardly to drain line connections 98 between end walls 102. Each tray has a pair of sidewalls 100, and may have handles 65 on end walls 102. When in place in the wash rack 12, each of the branch drain lines 22, 24, and 26 is connected to a respective tray drain line connection 98 for draining trapped used wash water from the trays. Any convenient number of trays and drain lines (which could be yoked together) may be employed in a particular tire wash installation.

In operation, a vehicle V is driven up ramp 14 to wash rack 12. High-pressure pumps 52 pump water from polished water holding tank 56 through high-pressure spray header supply lines 54 to spray header feed splitters 77. Water is fed to forward and rear spray headers 76 mounted on one of the spray units 56. Spray headers 76 supply the high-pressure water through feed tubes 81 to spray heads 70. Spray head feed splitters 77 also feed additional high-pressure supply lines 54 to additional forward and rear spray headers 76, feed tubes 81, and spray heads 70 on the opposite side spray unit 67. The high-pressure water spray at from about 900 psi to about 1500 psi or so reduces the time spent in cleaning tires T of vehicle V relative to conventional lower pressure spray units, and minimizes the amount of water needed for satisfactory cleaning. The used water is efficiently received by the outwardly splayed spray unit catch walls 74, and collected in collection pans 64, where water is drained through respective branch drain lines to the covered primary settling tank 16, thereby minimizing loss of water through evaporation, and the forming of puddles in the wash rack area. Partially clarified water is then directed to covered, secondary settling tank 18, and the clarified water is then returned to filtration and pump house 36, where the water is filtered by screen filters 42 and fiber filters 44 for return to the polished water holding tank 46 for use in cleaning the tires T of another vehicle. The collection trays 64 are periodically pulled out and cleaned of collected solids and debris.

The primary and secondary settling tanks (there could be a tertiary tank, if desired) are periodically serviced by a pumpout truck to remove settled solids. The facility may be moved to a new location by disassembling the wash racks, removal of the tanks, and filling of the holes left by the tanks, with the material supporting the wash rack ramps. The wash rack is easily disassembled by removing the hoses, lifting the spray units from the tubular vehicle support rack, lifting the vehicle support rack away from the intermediate support rack, and removing the collection trays. The pumphouse may be a portable building for easy removal an placement elsewhere.

The high-pressure spray system is preferably operated at from about 900 psi to 1500 psi or so pressure to the spray heads or nozzles. At least two high-pressure pumps, as shown, are preferred, but the system may have just a single pump, or additional pumps as may be required for any particular system.

It is to be understood that the present invention is not limited to the embodiments above described, but encompasses any and all embodiments within the scope of the following claims.

I claim:

1. A water recycling, high-pressure spray tire wash system, comprising:
a wash rack having a plurality of water collection trays;
a plurality of high-pressure spray heads spaced along said wash rack, and supported so as to direct high-pressure water spray toward the tires of a vehicle located on said wash rack;
a primary settling tank for partially clarifying waste water, and drain lines leading from said water collection trays to said primary settling tank;
a secondary settling tank for clarifying and polishing water received from said primary settling tank, and a drain line for conveying clarified water from said primary settling tank to said secondary settling tank;
a sump pump, a first line and a plurality of filters for conveying clarified water from said secondary tank;
a polished water holding tank and a second line for conveying water from said filters to said holding tank;
at least one high-pressure pump, and a corresponding line supplying water from said holding tank;
a corresponding high-pressure hose receiving water from said high-pressure pump; and
a corresponding high-pressure spray head manifold with said high-pressure spray heads, connected to said corresponding high-pressure hose, and configured for delivery of high-pressure water to said high-pressure spray heads.

2. The spray tire wash system of claim 1, wherein said wash rack is configured as a tubular, vehicle support unit, said tubes spaced apart a predetermined distance, so that waster water may pass therebetween, said collection trays located beneath said tubular, vehicle support unit.

3. The spray tire wash system of claim 2, wherein said wash rack is elevated, there further being a vehicle entrance ramp and a vehicle exit ramp to either side of and connected to said wash rack.

4. The spray tire wash system of claim 1, wherein said wash rack is elevated, there further being a vehicle entrance ramp and a vehicle exit ramp to either side of and connected to said wash rack.

5. The spray tire wash system of claim 1, wherein said drain line for conveying clarified water from said primary tank to said secondary tank is vented, located near the tops of the tanks, and configured such that water easily flows from said first tank to said second tank.

6. The spray tire wash system of claim 1, wherein each settling tank includes a lid.

7. The spray tire wash system of claim 1, wherein there are multiple high-pressure hoses receiving water from said high-pressure pump, and a pair of manifolds on said wash rack, on either side thereof.

8. The spray tire wash system of claim 7, wherein there are two of said high pressure pumps, arranged in parallel fashion, for supplying high-pressure water to said manifolds.

9. A method for washing vehicle tires comprising the steps of:
providing a vehicle wash rack having used wash water catch trays therebeneath, and a plurality of high-pressure cleaning water spray nozzles spaced along the wash rack;
driving a vehicle having exposed tires onto the wash rack;
spraying the tires with water sprayed from the water spray nozzles at a pressure from about 900 psi to about 1500 psi;
collecting used wash water in the collection trays beneath the wash rack;
conveying the collected water to a primary tank for settling of debris and solids and thus resulting in partially clarified water;
conveying the partial clarified water to at least one additional, secondary tank for further settling, thus resulting in polished water;
pumping the polished water through filters to a polished water holding tank; and
pumping water from the polished water holding tank at high pressure to the high-pressure spray nozzles.

10. The tire washing method of claim 9, wherein the water is sprayed from the water spray nozzles at about 900 psi.

11. The tire washing method of claim 9, wherein the water is sprayed from the water spray nozzles at about 1500 psi.

12. The tire washing method of claim 9, wherein the water is pumped from the polished water holding tank via pumps arranged in parallel to spray nozzles arrayed on both sides of the wash rack.

13. The tire washing method of claim 9, wherein the two settling tanks are disposed so that water flows from the primary tank to the secondary tank solely by force of gravity.

14. The tire washing method of claim 9, wherein the wash rack, collection trays and spray nozzles are retained together solely by force of gravity, so as to be easily disassembled and moved to a new location.
